(19) United States
(12) Patent Application Publication
(10) Pub. No.: US 2024/0295674 A1
(43) Pub. Date: Sep. 5, 2024

(54) POLARIZING PLATE AND OPTICAL DISPLAY APPARATUS

(71) Applicant: SAMSUNG SDI CO., LTD., Yongin-si (KR)

(72) Inventors: Hyeon Im JOUNG, Suwon-si (KR); Il Woong BAEK, Suwon-si (KR); Seo Young KANG, Suwon-si (KR)

(21) Appl. No.: 18/589,019

(22) Filed: Feb. 27, 2024

(30) Foreign Application Priority Data
Mar. 2, 2023 (KR) 10-2023-0027992

(51) Int. Cl. G02B 1/14; G02B 5/30; G02F 1/1335

(52) U.S. Cl. CPC G02B 1/14; G02B 5/30; G02F 1/133502; G02F 1/133528

(57) ABSTRACT

A polarizing plate and an optical display apparatus including the same are provided. A polarizing plate includes: a polarizer; and a first protective film stacked on a surface of the polarizer, and the first protective film has a total haze of 40% to 60% and an internal haze of 3% to 7%, and the polarizing plate has a light transmittance ratio of 0.008 or less, as calculated according to Equation 1.

### CROSS-REFERENCE TO RELATED APPLICATION

The present application claims priority to and the benefit of Korean Patent Application No. 10-2023-0027992, filed on Mar. 2, 2023 in the Korean Intellectual Property Office, the entire disclosure of which is incorporated herein by reference.

### BACKGROUND

### 1. Field

Aspects of embodiments of the present invention relate to a polarizing plate and an optical display apparatus.

### 2. Description of the Related Art

A liquid crystal display realizes a screen by allowing light emitted from a backlight unit to sequentially pass through a light source-side polarizing plate, a liquid crystal panel and a viewer-side polarizing plate. The liquid crystal display typically requires a high contrast ratio.

In recent years, a liquid crystal display, particularly a TV, is required not only to display a mobile image on a screen, but also to allow a TV screen to act as a picture frame showing a picture or a photo through reproduction of the picture or the photo on the TV screen. Typically, such a TV is referred to as a non-driven frame TV. The non-driven frame TV is fundamentally required to allow the picture or the photo to be clearly observed. Moreover, the non-driven frame TV is essentially required to reproduce the original texture of the picture or the photo (also known as “matte texture”) so that the picture or the photo appears to stick to the screen instead of floating off the screen. In addition, the non-driven frame TV requires a polarizing plate that increases the contrast ratio while realizing a matte texture.

The background technique of the present invention is disclosed in Japanese Unexamined Patent Publication No. 2006-251659.

### SUMMARY

According to an aspect of embodiments of the present invention, a polarizing plate that can provide a matte texture to a picture or a photo on a screen of an optical display apparatus and high contrast ratio is provided.

According to an aspect of one or more embodiments of the present invention, a polarizing plate is provided.

According to one or more embodiments, a polarizing plate includes: a polarizer; and a first protective film stacked on a surface of the polarizer, wherein the first protective film has a total haze of 40% to 60% and an internal haze of 3% to 7%, and the polarizing plate has a light transmittance ratio of 0.008 or less, as calculated according to the following Equation 1:

Light transmittance ratio=Tc(380 nm to 420 nm)/Tc(780 nm), Equation 1

where Tc (780 nm) denotes a crossed transmittance of the polarizing plate at a wavelength of 780 nm (unit: %), and Tc (380 nm to 420 nm) denotes a maximum value of a crossed transmittance of the polarizing plate at a wavelength of 380 nm to 420 nm (unit: %).

In one or more embodiments, the first protective film may have an external haze-to-internal haze ratio of 9 to 20.

In one or more embodiments, the first protective film may include a base layer and an antiglare layer stacked on a surface of the base layer.

In one or more embodiments, the antiglare layer may include at least one selected from among organic particles and inorganic particles.

In one or more embodiments, the polarizing plate may have a light transmittance ratio of 0.003 to 0.008, as calculated according to Equation 1.

In one or more embodiments, the polarizing plate may have a crossed transmittance of 0% to 20% at a wavelength of 780 nm.

In one or more embodiments, the maximum value of the crossed transmittance of the polarizing plate at a wavelength of 380 nm to 420 nm may be present at a wavelength of 395 nm to 410 nm.

In one or more embodiments, the maximum value of the crossed transmittance of the polarizing plate at a wavelength of 380 nm to 420 nm may be 0.001% to 0.1%.

In one or more embodiments, the polarizing plate may have a Tc-to-total haze ratio of 0.35 or less, as calculated according to the following Equation 2:

Tc-to-total haze ratio=Tc(780 nm)/total haze, Equation 2

where the total haze is a total haze of the first protective film (unit: %), and Tc (780 nm) denotes a crossed transmittance of the polarizing plate at a wavelength of 780 nm (unit: %).

In one or more embodiments, the polarizing plate may have a Tc-to-internal haze ratio of 5.0 or less, as calculated according to the following Equation 3:

Tc-to-internal haze ratio=Tc(780 nm)/internal haze, Equation 3

where the internal haze is an internal haze of the first protective film (unit: %), and Tc (780 nm) denotes a crossed transmittance of the polarizing plate at a wavelength of 780 nm (unit: %).

In one or more embodiments, the polarizing plate may have a crossed transmittance of 1.0% to 1.3% in an MD (machine direction) of the polarizer and a crossed transmittance of 0.05% or less in a TD (transverse direction) of the polarizer at a wavelength of 380 nm.

In one or more embodiments, the first protective film may further include an antireflection layer stacked on a surface of the antiglare layer.

In one or more embodiments, the first protective film may be stacked alone on the surface of the polarizer.

In one or more embodiments, the polarizing plate may further include a second protective film stacked on another surface of the polarizer.

According to an aspect of one or more embodiments of the present invention, an optical display apparatus is provided.

In one or more embodiments, the optical display apparatus includes the polarizing plate according to an embodiment.

Embodiments of the present invention provide a polarizing plate that can provide a matte texture to a picture or a photo on a screen of an optical display apparatus and high contrast ratio.

### BRIEF DESCRIPTION OF THE DRAWINGS

FIG. 1 is a graph depicting a relationship between front contrast ratio and internal haze of a first protective film thereof in a typical polarizing plate (indicated by a dotted line) and a relationship between front contrast ratio and internal haze of a first protective film thereof in a polarizing plate according to an embodiment of the present invention (indicated by a solid line), in which the x-axis denotes the internal haze (unit: %) and the y-axis denotes the contrast ratio.

FIG. 2 is a graph depicting a relationship between crossed transmittance of a polarizing plate and wavelength.

FIG. 3 is a cross-sectional view of a polarizing plate according to an embodiment of the present invention.

### DETAILED DESCRIPTION

Herein, some embodiments of the present invention will be described in further detail with reference to the accompanying drawings such that the present invention can be implemented by those skilled in the art. However, it is to be understood that the present invention may be embodied in different ways and is not limited to the following embodiments.

The terminology used herein is for the purpose of describing some example embodiments and is not intended to limit the present invention. As used herein, the singular forms “a,” “an,” and “the” are intended to include the plural forms as well, unless the context clearly indicates otherwise.

In the drawings, portions irrelevant to the description may be omitted for clarity, and like components are denoted by like reference numerals throughout the specification. Although lengths, thicknesses or widths of various components may be exaggerated in the drawings for clarity of illustration of the invention, the present invention is not limited thereto.

Herein, spatially relative terms, such as “upper” and “lower,” are defined with reference to the accompanying drawings. Thus, it is to be understood that “upper surface” can be used interchangeably with “lower surface.” In addition, when an element, such as a layer or film, is referred to as being placed “on” another element, it may be directly placed on the other element, or one or more intervening elements may be present. On the other hand, when an element is referred to as being placed “directly on” another element, there are no intervening element(s) therebetween.

Herein, “in-plane retardation (Re)” is a value calculated according to the following Equation A:

Re=(nx−ny)×d, Equation A

where nx and ny are the indexes of refraction of an optical element, as measured in the slow axis-direction and fast axis-direction thereof at a measurement wavelength, respectively, and d is the thickness (unit: nm) of the optical element. Herein, the in-plane retardation is a value measured by transmitting light in the normal direction to the in-plane direction of the optical element.

Herein, “internal haze” of a first protective film is a value measured in the same manner as in measurement of a total haze of the first protective film after alcohol, for example, ethanol, is sprayed onto an alkali-free glass plate having a total haze of less than 1%, followed by adhering an antiglare layer of the first protective film to the alkali-free glass plate in order to flatten unevenness of the antiglare layer surface. “Total haze” of the first protective film is a value measured by a typical haze meter with respect to the first protective film. “External haze” of the first protective film may be a difference between the total haze of the first protective film and the internal haze thereof.

Herein, “haze” may be measured in the visible spectrum, for example, at a wavelength of 380 nm to 780 nm.

Herein, “single transmittance (Ts)” of a polarizing plate is a value calculated according to “(MD single transmittance of the polarizing plate+TD single transmittance of the polarizing plate)/2”.

Herein, “crossed transmittance (Tc)” of a polarizing plate is calculated according to “(MD crossed transmittance of the polarizing plate×TD crossed transmittance of the polarizing plate)/100”.

As used herein to represent a specific numerical range, “X to Y” means a value greater than or equal to X and less than or equal to Y.

According to embodiments of the present invention, a polarizing plate that can provide a matte texture to a picture or a photo on a screen of an optical display apparatus is provided. The polarizing plate can secure clarity of a picture or a photo and can reproduce an original texture (“matte texture”) of the picture or the photo such that the picture or the photo appears to stick to the screen instead of floating off the screen.

Further, according to embodiments of the present invention, a polarizing plate can provide high contrast ratio.

In one or more embodiments, the polarizing plate may be used as a viewer-side polarizing plate in a liquid crystal display.

In one or more embodiments, the polarizing plate includes: a polarizer; and a first protective film stacked on a surface of the polarizer, wherein the first protective film has a total haze of 40% to 60% and an internal haze of 3% to 7%. The polarizing plate according to embodiments of the present invention provides a matte texture of a picture or a photo on a screen of an optical display apparatus through adjustment in total haze and internal haze of the first protective film disposed on a light exit surface of the polarizer within the scope of the present invention. Here, the “light exit surface” of the polarizer is a surface through which internal light emitted from a backlight unit or the like is emitted from the polarizer through the polarizer.

In one or more embodiments, the first protective film may have a total haze of 40, 41, 42, 43, 44, 45, 46, 47, 48, 49, 50, 51, 52, 53, 54, or 55% and an internal haze of 3, 3.5, 4, 4.5, 5, 5.5, 6, 6.5, or 7%.

In an embodiment, the first protective film may have a total haze of 40% to 55%, and, in an embodiment, 40% to 50%, and, in an embodiment, 40% to 46%. In an embodiment, the first protective film may have an internal haze of 3% to 6.5%, and, in an embodiment, 3% to 6%, and, in an embodiment, 3% to 5.5%. Within this range, the polarizing plate can easily provide the matte texture.

In an embodiment, the first protective film may have the total haze of 40% to 46% and the internal haze of 3% to 5.5%. Within this range, the polarizing plate can provide the matte texture and can easily improve the contrast ratio described below.

In an embodiment, the first protective film may have an external haze of 35% to less than 60%, for example, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, or 59%, and, in an embodiment, 35% to 55%, and, in an embodiment, 35% to 50%. Within this range, the first protective film can easily achieve the total haze and the internal haze of the present invention.

In an embodiment, the first protective film may have a ratio of external haze to internal haze in a range of 9 to 20, for example, 9, 10, 11, 12, 13, 14, 15, 16, 17, 18, 19, or 20, and, in an embodiment, 9 to 15. Within this range, the polarizing plate can easily realize the matte texture and can easily achieve the crossed transmittance ratio described below.

The first protective film may include a base layer and an antiglare layer stacked on a surface of the base layer.

The base layer may support the antiglare layer.

In an embodiment, each of internal haze, external haze, and total haze of the base layer may be 1% or less, for example, 0% to 0.5%. Within this range, the base layer does not affect the total haze and internal haze of the first protective film.

The base layer may include an optically transparent base film, for example, a base film having a light transmittance of 90% or more in the visible spectrum. The base layer may further include a coating layer formed on at least one surface of the base film.

In an embodiment, the base layer may be composed of the base film alone. The base film may be a film including an optically transparent resin. For example, the base film may be a film formed of at least one resin selected from among cellulosic based resins including triacetylcellulose (TAC) and the like, polyester based resins including polyethylene terephthalate (PET), polybutylene terephthalate, polyethylene naphthalate, polybutylene naphthalate, and the like, acrylic based resins, cyclic olefin polymer (COP) based resins, cyclic olefin copolymer (COC) based resins, polycarbonate based resins, polyether sulfone based resins, polysulfone based resins, polyamide based resins, polyimide based resins, polyolefin based resins, polyarylate based resins, polyvinyl alcohol based resins, polyvinyl chloride based resins, and polyvinylidene chloride based resins. In an embodiment, the base film may be a polyethylene terephthalate or acrylic based film.

The base film may be uniaxially or biaxially stretched to provide in-plane retardation described below. In an embodiment, the base film may be prepared by preparing a non-stretched film from a composition for base films including the resin and stretching the non-stretched film uniaxially in the machine direction (MD), uniaxially in the transverse direction (TD), or biaxially in the MD and the TD. The stretching ratio may be suitably selected in consideration of the thickness of the non-stretched film, target in-plane retardation, stretching temperature, and the like. For example, the stretching ratio may be set to 2 to 7 times, or 3 to 8 times. The stretching temperature may be adjusted according to the glass transition temperature (Tg) of the non-stretched film, for example, Tg±20° C. Stretching may be performed by a typical method known to those skilled in the art.

In an embodiment, the base film, and, in an embodiment, the base layer, may have an in-plane retardation of 5,000 nm or more, and, in an embodiment, 5,000 nm to 15,000 nm, and, in an embodiment, 5,000 nm to 12,000 nm, at a wavelength of 550 nm. Within this range, the base film can improve front contrast ratio while suppressing rainbow mura and the like.

In another embodiment, the base film, and, in an embodiment, the base layer, may have an in-plane retardation of less than 5,000 nm, and, in an embodiment, 0 to 1,000 nm, and, in an embodiment, 0 to less than 100 nm, or 0 to less than 50 nm at a wavelength of 550 nm.

In another embodiment, the base layer may further include a primer layer as the coating layer. The primer layer may improve adhesion to an adherend or an antiglare layer. The primer layer may be formed of a composition including a resin for the primer layer, such as a urethane based resin, an acrylic based resin, a polyester based resin, and the like, without affecting the effects of the first protective film.

In an embodiment, the base layer may have a thickness of 40 μm to 100 μm, and, in an embodiment, 50 μm to 90 μm. Within this range, the base layer may be a support for the first protective film.

The antiglare layer may provide the total haze and internal haze of the first protective film.

In an embodiment, the antiglare layer is formed directly on the base layer. Here, “formed directly” means that the base layer and the antiglare layer are directly stacked without any adhesive layer, bonding layer, adhesive/bonding layer, or any other optical layer therebetween. In an embodiment, the antiglare layer may be formed by directly coating a composition for the antiglare layer on the base layer.

For the antiglare layer, the surface of the antiglare layer and/or the composition for the antiglare layer may be adjusted so as to achieve the total haze and internal haze of the first protective film. The first protective film is a protective film with high haze, as described above. Such high haze can be achieved by adjusting an average particle diameter of organic particles and/or inorganic particles in the antiglare layer, or by adjusting the degree of roughness on the outermost surface of the antiglare layer.

In an embodiment, a surface of the antiglare layer, and, in an embodiment, a surface of the antiglare layer opposite the base layer, may be formed with fine roughness.

The fine roughness may be caused by the structure of the antiglare layer including at least one selected from among inorganic particles and organic particles described below. With the fine roughness, the antiglare layer can have the total haze and the internal haze within the scope of the present invention.

Next, the organic particles contained in the antiglare layer will be described. The organic particles may be contained in the composition for the antiglare layer and may have a different refractive index than a matrix for the antiglare layer to allow adjustment in haze of the first protective film and improvement in effects of the present invention by providing a range (e.g., a predetermined range) of surface roughness Sa to the antiglare layer.

In an embodiment, in the antiglare layer, the organic particles may be present in an amount of 5 wt % to 50 wt %, for example, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, or 50 wt %, and, in an embodiment, 10 wt % to 40 wt %, and, in an embodiment, 10 wt % to 20 wt %. Within this range, the organic particles can provide an antiglare effect.

The organic particles may be any of microparticles, nanoparticles, and the like, and may have any suitable shape, such as a spherical shape, an amorphous shape, and the like, without being limited thereto. In an embodiment, the organic particles may have an average particle diameter (D50) of 0.01 μm to 6 μm. Within this range, the organic particles can provide the antiglare effect. For example, the organic particles may have an average particle diameter (D50) of 0.01 μm, 0.05 μm, 0.1 μm, 0.5 μm, 1 μm, 1.5 μm, 2 μm, 2.5 μm, 3 μm, 3.5 μm, 4 μm, 4.5 μm, 5 μm, 5.5 μm, or 6 μm. The organic particles are contained in a composition including a resin for the antiglare layer and, in an embodiment, have an average particle diameter (D50) of 0.5 μm to 5.5 μm, and, in an embodiment, 1 μm to 5 μm, for formation of the antiglare layer.

As used herein, “average particle diameter (D50)” means a typical average particle size (D50) known to those skilled in the art and means a particle diameter of the organic particles corresponding to 50 vol % when the organic particles are distributed in order from smallest to largest in terms of volume.

In an embodiment, the organic particles have a higher refractive index than the matrix for the antiglare layer and may have a refractive index of 1.30 to 1.70, and, in an embodiment, 1.40 to 1.60. Within this range, the antiglare layer according to the present invention can be easily obtained.

The organic particles may be suitably selected from organic particles having the indexes of refraction described above.

For example, although the organic particles may include core-shell type organic particles, the organic particles, in an embodiment, are non-core-shell type organic particles, that is, organic particles composed of a single material. The single material for the organic particles may be polyacrylate based particles, polymethacrylate based particles including poly(methyl methacrylate) (PMMA) and the like, polystyrene (PS) based particles, silicone based particles, polycarbonate based particles, polyolefin based particles, polyester based particles, polyamide based particles, polyimide based particles, polyfluoroethylene based particles, poly(methyl methacrylate)-polyacrylate based particles, polyacrylate-polystyrene based particles, melamine based particles, or the like.

In an embodiment, the organic particles may be a mixture of polystyrene based particles; and polyacrylate based or polymethacrylate based particles.

The antiglare layer may include the organic particles and a matrix for the antiglare layer in which the organic particles are dispersed, and the matrix for the antiglare layer may have a lower refractive index than the organic particles. The antiglare layer may be formed of a composition including the organic particles and an actinic radiation-curable compound. The actinic radiation-curable compound may include an actinic radiation-curable resin or oligomer and an actinic radiation-curable monomer. The actinic radiation-curable resin or oligomer may be selected from any type known to those skilled in the art.

The composition may further include at least one photoinitiator selected from among a photo-radical initiator and a photo-cationic initiator. The photoinitiator can cure an actinic radiation-curable resin and an actinic radiation-curable monomer. The photo-radical initiator may include a photo-radical initiator, such as an acetophenone-based initiator, a cyclohexylketone-based initiator, and the like.

In an embodiment, the composition may include 5 wt % to 50 wt %, and, in an embodiment, 10 wt % to 40 wt %, and, in an embodiment, 10 wt % to 20 wt %, of the organic particles, 20 wt % to 80 wt %, and, in an embodiment, 50 wt % to 70 wt %, of the actinic radiation-curable resin or oligomer, 10 wt % to 80 wt %, and, in an embodiment, 10 wt % to 30 wt %, of the actinic radiation-curable monomer, and 1 wt % to 10 wt % of the photoinitiator in terms of solid content.

The composition for the antiglare layer may include any suitable solvent in an amount not dissolving the organic particles. The solvent may be methyl ethyl ketone, propylene glycol methyl ether, and the like, without being limited thereto.

The composition for the antiglare layer may further include typical additives that can be included in the antiglare layer. The antiglare layer may be formed by depositing the composition for the antiglare layer on a surface of the base layer, followed by drying and curing the composition. Curing may be performed by a typical method known to those skilled in the art, such as heat curing, light curing, and the like.

In an embodiment, the antiglare layer may have a thickness of 1 μm to 8 μm, for example, 1 μm, 2 μm, 3 μm, 4 μm, 5 μm, 6 μm, 7 μm, or 8 μm, and, in an embodiment, 2 μm to 7 μm. Within this range, the antiglare layer can be included in the first protective film.

The first protective film may further include an antireflection layer stacked on a surface of the antiglare layer.

The antireflection layer can effectively realize the effect of the present invention by reducing reflectivity of the polarizing plate having the first protective film.

In an embodiment, the first protective film may have a reflectivity of 2% or less, for example, 1% to 2%.

In an embodiment, the antireflection layer may be directly formed on the antiglare layer. Here, “directly formed” means that the antireflection layer is directly interposed between the antiglare layer and the antireflection layer without any adhesive layer, bonding layer, adhesive/bonding layer, or any other optical layer therebetween. In an embodiment, the antireflection layer may be formed by directly coating a composition for the antireflection layer on the antiglare layer.

In an embodiment, the antireflection layer may have a refractive index of 2.0 or less, for example, 1.1, 1.2, 1.3, 1.4, 1.5, 1.6, 1.7, 1.8, 1.9, or 2.0, for example, 1.2 to 1.4. Within this range, the antireflection layer can easily reach reflectivity of the present invention. The antireflection layer can provide reflectivity of the present invention by adjusting the composition for the antireflection layer.

The composition for the antireflection layer may include at least one selected from among inorganic particles and a fluorine based compound. The inorganic particles and the fluorine based compound can reduce the refractive index of the antireflection layer.

The inorganic particles may have a hollow shape to provide a low index of refraction. For example, the inorganic particles may be inorganic particles with a low index of refraction, and, in an embodiment, hollow silica. In an embodiment, the inorganic particles may have a refractive index of less than 1.5, for example, 1.0 to less than 1.5. Within this range, the inorganic particles can easily reduce the refractive index of the antireflection layer.

The inorganic particles have a smaller average particle diameter (D50) than the thickness of the antireflection layer, whereby the surface roughness Sa of the antireflection layer can be easily achieved. In an embodiment, the inorganic particles may have an average particle diameter (D50) of 50 nm to 150 nm, for example, 50 nm to 120 nm.

In an embodiment, in the antireflection layer, the inorganic particles may be present in an amount of 30 wt % to 70 wt %, for example, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, or 70 wt %, and, in an embodiment, 40 wt % to 60 wt %, for example, 50 wt % to 60 wt %. Within this range, the antireflection layer can easily reach the reflectivity of the present invention.

The fluorine based compound can facilitate reducing the refractive index of the antireflection layer even with a small amount of the inorganic particles. The fluorine based compound may include a fluorine-containing (meth)acrylate based monomer, an oligomer thereof, or a resin thereof.

The composition for the antireflection layer may further include at least one selected from among an actinic radiation-curable resin or oligomer and an actinic radiation-curable monomer, and a photoinitiator in addition to the inorganic particles and the fluorine compound. The actinic radiation-curable resin and the actinic radiation-curable monomer are cured to make it easy to form the matrix of the antireflection layer and to allow particles having a low index of refraction to be stably contained in the antireflection layer. The actinic radiation-curable resin, the actinic radiation-curable monomer, and the photoinitiator may be the same as those described above in the antiglare layer.

In an embodiment, the composition for the antireflection layer may include 20 wt % to 80 wt % of at least one selected from among the actinic radiation-curable resin, the actinic radiation-curable oligomer and the actinic radiation-curable monomer, 30 wt % to 70 wt %, and, in an embodiment, 50 wt % to 70 wt %, of the inorganic particles, 1 wt % to 10 wt % of the fluorine based compound, and 1 wt % to 10 wt % of the photoinitiator in terms of solid content. Within this range, the composition can easily form the antireflection layer according to the present invention.

The composition for the antireflection layer may further include typical additives that can be contained in the antireflection layer. For example, the additives may impart an antifouling function and slimness to the antireflection layer, and may include typical additives known to those skilled in the art. The additives may include at least one selected from among fluorine-containing additives and silicone-based additives. The antireflection layer may be formed by depositing the composition for the antireflection layer on a surface of the base layer, followed by drying and curing. Curing may be performed by a typical method known to those skilled in the art, such as heat curing, photocuring, and the like.

In an embodiment, the antireflection layer may have a thickness of 60 nm to 200 nm, and, in an embodiment, 80 nm to 150 nm. Within this range, the antireflection layer can be contained in the first protective film.

The first protective film may be stacked on the polarizer by a typical manner. For example, the first protective film may be stacked on the polarizer by a bonding layer formed of a water-based or photocurable bonding agent.

In an embodiment, the first protective film may be stacked alone on the polarizer. With this structure, the effects of the present invention can be achieved.

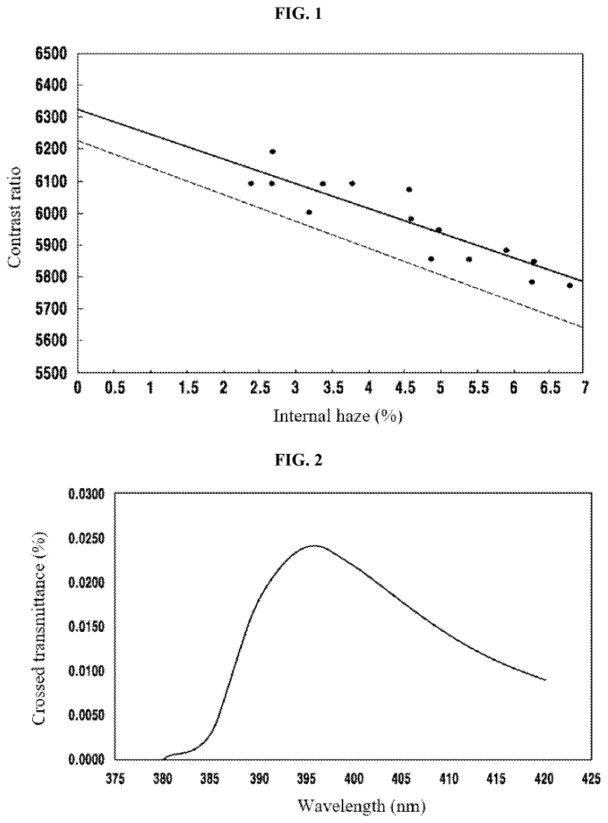

The inventors of the present invention manufactured a polarizing plate provided with a first protective film having various internal haze values including the internal haze of the present invention and measured the contrast ratio under the same condition. Measurement of the contrast ratio was performed in the same manner as in measurement of contrast ratio described below. FIG. 1 shows a measurement result. The first protective film used herein had the internal haze with a value shown on the X-axis in FIG. 1 and had the same total haze of 46%.

Referring to FIG. 1, for a typical polarizing plate (indicated by a dotted line, the ratio of Equation 1 exceeds 0.008), higher internal haze indicates lower contrast ratio. For a polarizing plate including a first protective film having an internal haze of 3% to 7%, it could be confirmed that the contrast ratio was reduced as the internal haze increased from 3% to 7%. In particular, the polarizing plate including the first protective film having an internal haze of 3% to 7% failed to secure a clear screen due to a very low front contrast ratio.

According to the present invention, a polarizing plate including a first protective film having a total haze of 40% to 60% and an internal haze of 3% to 7% has a light transmittance ratio of 0.008 or less, as calculated according to Equation 1, thereby achieving remarkable improvement in contrast ratio despite the presence of the first protective film having the total haze and the internal haze within the above ranges. Referring to FIG. 1, it could be seen that the polarizing plate (indicated by a solid line) according to the present invention provided a higher contrast ratio even at an internal haze of 3% to 7% than a typical polarizing plate. Referring to FIG. 1, although the polarizing plate can have a contrast ratio of less than 6,000 even at an internal haze of 3% to 7%, a contrast ratio of 6,000 or more can be sufficiently realized through adjustment in total haze of the first protective film. The contrast ratio may be measured by a method described below.

The polarizing plate according to one or more embodiments has a light transmittance ratio of 0.008 or less, as calculated according to Equation 1. With a light transmittance ratio of greater than 0.008, as calculated according to Equation 1, the polarizing plate cannot improve the contrast ratio with realizing the matte texture without affecting a visibility on the frame type screen.

$$Light transmittance ratio = Tc ( 380 nm to 420 nm / Tc ( 780 nm ) , \qquad Equation 1$$

where Tc (780 nm) denotes a crossed transmittance of the polarizing plate at a wavelength of 780 nm (unit: %), and Tc (380 nm to 420 nm) denotes a maximum value of a crossed transmittance of the polarizing plate at a wavelength of 380 nm to 420 nm (unit: %).

For example, the polarizing plate may have a light transmittance ratio of 0.001, 0.0015, 0.002, 0.0025, 0.003, 0.0035, 0.004, 0.0045, 0.005, 0.0055, 0.006, 0.0065, 0.007, 0.0075, or 0.008, as calculated according to Equation 1.

The polarizing plate may have a light transmittance ratio of greater than 0 to 0.008, for example. 0.003 to 0.008, and, in an embodiment, 0.005 to 0.008, and, in an embodiment, 0.005 to 0.0075. Within this range, the polarizing plate can secure improvement in contrast ratio and can prevent or substantially prevent a reddish color from appearing in a black mode of a display apparatus, thereby preventing or substantially preventing a picture or a photo from appearing relatively red when viewed thereon.

Equation 1 is obtained in consideration of the ratio of the maximum value of the crossed transmittances of the polarizing plate at a wavelength of 380 nm to 420 nm to crossed transmittance of the polarizing plate at a wavelength of 780 nm. Considering both crossed transmittance of the polarizing plate at a wavelength of 380 nm to 420 nm, which corresponds to the minimum wavelength range among wavelengths of 380 nm to 780 nm known as a typical visible range, and crossed transmittance of the polarizing plate at a wavelength of 780 nm, which corresponds to the maximum wavelength thereamong, the inventors of the present invention set the light transmittance ratio within a range (e.g., a predetermined range) to provide the effects of achieving improvement in contrast ratio while preventing or substantially preventing a reddish color from appearing in the black mode even in use of the polarizing plate including the first protective film having the internal haze and the total haze described above.

In an embodiment, the polarizing plate may have a crossed transmittance of 0% to 20%, for example, 0%, 1%, 2%, 3%, 4%, 5%, 6%, 7%, 8%, 9%, 10%, 11%, 12%, 13%, 14%, 15%, 16%, 17%, 18%, 19%, or 20%, and, in an embodiment, 5% to 15%, and, in an embodiment, 6% to 14%, and, in an embodiment, 6% to 10%, at a wavelength of 780 nm. Within this range, the polarizing plate can easily reach the light transmittance ratio of Equation 1 according to the present invention.

In an embodiment, the polarizing plate may have a maximum value of the crossed transmittances of 0.001% to 0.1%, for example, 0.0015%, 0.0055%, 0.015%, 0.025%, 0.035%, 0.045%, 0.055%, 0.065%, 0.075%, 0.085%, 0.095%, or 0.1%, and, in an embodiment, 0.01% to 0.09%, and, in an embodiment, 0.02% to 0.07%, at a wavelength of 380 nm to 420 nm. Within this range, the polarizing plate can easily reach the light transmittance ratio of Equation 1 according to the present invention.

In an embodiment, the maximum value of a crossed transmittance at a wavelength of 380 nm to 420 nm may be at a wavelength of 380 nm to 410 nm, 390 nm to 410 nm, 395 nm to 410 nm, or, for example, 390 nm to 400 nm.

FIG. 2 is a graph depicting variation of crossed transmittance of a polarizing plate depending on wavelength. Referring to FIG. 2, in the polarizing plate according to the present invention, the maximum value of a crossed transmittance at a wavelength of 380 nm to 420 nm may be at a wavelength of 395 nm to 410 nm, for example, 390 nm to 400 nm.

In an embodiment, the polarizing plate may have a crossed transmittance of 0.001% to 0.04%, and, in an embodiment, 0.003% to 0.03%, and, in an embodiment, 0.005% to 0.015%, at a wavelength of 420 nm. Within this range, the polarizing plate can improve polarization performance.

In an embodiment, the polarizing plate may have a crossed transmittance of 1.0% to 1.3% at a wavelength of 380 nm in the MD of the polarizer and a crossed transmittance of 0.05% or less, for example, 0% to 0.05%, or 0.02% to 0.05%, at a wavelength of 380 nm in the TD of the polarizer.

In an embodiment, the polarizing plate may have a single transmittance Ts of 43% to 45%, and, in an embodiment, 43.85 to 45%. Within this range, the contrast ratio of the polarizing plate can be advantageously improved.

For the polarizing plate, the light transmittance ratio of 0.008 or less as calculated according to Equation 1 may be realized by a polyvinyl alcohol based film and a polarizer manufactured by a manufacturing process.

The polarizer includes a light absorbing polarizer that divides incident light into two crossed polarization components and transmits one polarization component while absorbing the other polarization component.

The polarizer may include a uniaxially stretched polarizer containing a dichroic dye. In an embodiment, a polarizer containing a dichroic dye may include a polarizer manufactured by uniaxially stretching a base film for the polarizer in the MD and dyeing the stretched base film with the dichroic dye (e.g., iodine or an iodine-containing substance including potassium iodide). The base film for the polarizer may include a polyvinyl alcohol based film or a derivative thereof, without being limited thereto. The polarizer may be manufactured by a typical method known to those skilled in the art.

In an embodiment, the polarizer may have a thickness of 1 μm to 40 μm, and, in an embodiment, 15 μm to 30 μm, and, in an embodiment, 16 μm to 20 μm. Within this range, the polarizer can be used in the polarizing plate.

The polyvinyl alcohol based film may be a typical polyvinyl alcohol based film known to those skilled in the art.

In an embodiment, the polyvinyl alcohol based film contains hydrophilic functional groups and hydrophobic functional groups. The hydrophobic functional group is present in addition to a hydroxyl (OH) group present as the hydrophilic functional group in the polyvinyl alcohol based film. By preparing the polyvinyl alcohol based film containing both the hydrophilic functional group and the hydrophobic functional group through a process described below, the polarizing plate according to the present invention can easily reach the ratio of Equation 1.

The hydrophobic functional group is present in a main chain and/or a side chain of a polyvinyl alcohol based resin constituting the polyvinyl alcohol based film. The “main chain” means a portion constituting the main backbone of the polyvinyl alcohol based resin, and the “side chain” means a backbone connected to the main chain. In an embodiment, the hydrophobic functional group may be present in the main chain of the polyvinyl alcohol based resin.

The polyvinyl alcohol based resin having the hydrophilic functional groups and hydrophobic functional groups may be prepared by polymerizing at least one or at least two vinyl ester monomer, such as vinyl acetate, vinyl formate, vinyl propionate, vinyl butyrate, vinyl pivalate, and isopropenyl acetate, with a monomer providing a hydrophobic functional group. In an embodiment, the vinyl ester monomer may include vinyl acetate. The monomer providing the hydrophobic functional group may include a monomer providing a hydrocarbon repeat unit including ethylene, propylene, and the like.

In an embodiment, the polyvinyl alcohol based film may have a thickness of 50 μm or less, for example, 10 μm to 50 μm. Within this range, the polyvinyl alcohol based film does not suffer from melting and fracture when stretched.

The polarizer may be manufactured by subjecting the polyvinyl alcohol based film to dyeing, stretching, crosslinking, color correction, and drying processes, as described below. The sequence of the dyeing, stretching, and crosslinking processes may be changed depending on the kind of polyvinyl alcohol based film and a polarizer manufacturing process.

The dyeing process includes treatment of the polyvinyl alcohol based film in a dyeing bath containing a dichroic material. In the dyeing process, the polyvinyl alcohol based film is dipped in the dyeing bath containing the dichroic material. The dyeing bath containing the dichroic material includes an aqueous solution containing the dichroic material and boric acid. As the dyeing bath includes both the dichroic material and a boron compound, the polyvinyl alcohol based film can be prevented or substantially prevented from fracture even when dyed and stretched under the following stretching conditions.

In an embodiment, the dichroic material is iodine and may include at least one selected from among potassium iodide, hydrogen iodide, lithium iodide, sodium iodide, zinc iodide, aluminum iodide, lead iodide, and copper iodide. In an embodiment, the dichroic material may be present in an amount of 0.5 mol/ml to 10 mol/ml, and, in an embodiment, 0.5 mol/ml to 5 mol/ml, in the dyeing bath, and, in an embodiment, in the dyeing aqueous solution. Within this range, uniform dyeing can be achieved.

The boron compound can assist in prevention of melting and fracture of the polyvinyl alcohol based film upon stretching of the polyvinyl alcohol based film. The boron compound can assist in prevention of melting and fracture of the polyvinyl alcohol based film in the stretching process after the dyeing process, even when the polyvinyl alcohol film is stretched at high temperature and high stretching ratio.

The boron compound may include at least one selected from among boric acid and borax. In an embodiment, the boron compound may be present in an amount of 0.1 wt % to 5 wt %, and, in an embodiment, 0.3 wt % to 3 wt %, in the dyeing bath, and, in an embodiment, in the dyeing aqueous solution. Within this range, the polyvinyl alcohol based film does not suffer from melting and fracture in the stretching process and can achieve high reliability.

In an embodiment, the dyeing solution may have a temperature of 20° C. to 50° C., and, in an embodiment, 25° C. to 40° C. In the dyeing process, the polyvinyl alcohol based film may be dipped in the dyeing bath for 30 seconds to 120 seconds, and, in an embodiment, 40 seconds to 80 seconds.

The stretching process includes stretching the dyed polyvinyl alcohol based film at a stretching ratio of at least 5.7 times, for example, 5.7 times to 7 times, at a temperature of 57° C. or more, for example, at 57° C. to 65° C.

The stretching process is performed by either wet stretching or dry stretching. In an embodiment, the stretching process includes wet stretching in order to apply the boron compound in the stretching process. Wet stretching includes uniaxial stretching of the polyvinyl alcohol based film in the machine direction in an aqueous solution containing a boron compound.

The boron compound may include at least one selected from among boric acid and borax, and, in an embodiment, boric acid. In an embodiment, the boron compound may be present in an amount of 0.5 wt % to 10 wt %, and, in an embodiment, 1 wt % to 5 wt %, in a stretching bath, and, in an embodiment, in a stretching aqueous solution. Within this range, the polyvinyl alcohol based film does not suffer from melting and fracture in the stretching process and can achieve high reliability.

The crosslinking process is performed to enhance adsorption of the dichroic material to the stretched polyvinyl alcohol based film. In an embodiment, a crosslinking solution used in the crosslinking process includes a boron compound. The boron compound can assist in strong adsorption of the dichroic material described above while improving reliability of the polarizer even when the polarizer is left under a thermal shock condition.

The boron compound may include at least one selected from among boric acid and borax. In an embodiment, the boron compound may be present in an amount of 0.5 wt % to 10 wt %, and, in an embodiment, 1 wt % to 5 wt %, in a crosslinking bath, and, in an embodiment, in a crosslinking aqueous solution. Within this range, the polyvinyl alcohol based film does not suffer from melting and fracture in the stretching process and can achieve high reliability. In an embodiment, the crosslinking bath may have a temperature of 20° C. to 50° C., and, in an embodiment, 25° C. to 40° C. The crosslinking process may be performed by dipping the polyvinyl alcohol based film in the crosslinking bath for 30 seconds to 120 seconds, and, in an embodiment, for 40 seconds to 80 seconds.

The color correction process can improve durability of the polarizer. A color correction bath may include a color correction solution containing greater than 0 wt % to 10 wt %, and, in an embodiment, 1 wt % to 5 wt %, of potassium iodide. The color correction solution may have a temperature of 20° C. to 50° C., and, in an embodiment, 25° C. to 40° C. The color correction process may be performed by dipping the polyvinyl alcohol based film in the color correction bath for 5 seconds to 50 seconds, and, in an embodiment, 5 seconds to 20 seconds.

The drying process may be performed by drying the polyvinyl alcohol based film at 30° C. to 80° C., and, in an embodiment, 40° C. to 80° C., for 2 minutes or less, and, in an embodiment, for 1 minute to 2 minutes, after the color correction process. The drying process may be performed by hot air drying, but is not limited thereto.

In an embodiment, the light transmittance ratio of 0.008 or less as calculated in Equation 1 may be realized by adjusting the conditions for the stretching process, for example, the stretching ratio, the stretching temperature, and the like, in the process of manufacturing the polarizer. In an embodiment, the light transmittance ratio of 0.008 or less as calculated in Equation 1 may be realized by adjusting the conditions for the color correction and drying processes, in the process of manufacturing the polarizer. The polarizing plate according to the present invention includes the polarizer manufactured by the above method in order to satisfy the light transmittance ratio within the scope of the present invention in a structure where a high haze first protective film having a total haze of 40% to 60% is stacked on a light exit surface of the polarizer.

The polyvinyl alcohol based film may be subjected to a washing process and/or a swelling process before the dyeing process.

In the washing process, the polyvinyl alcohol based film is washed with water to remove foreign matter from the polyvinyl alcohol based film.

In the swelling process, the polyvinyl alcohol based film is dipped in a swelling bath in a temperature range (e.g., a predetermined temperature range) to facilitate dyeing with the dichroic material and stretching. The swelling process may be performed at 15° C. to 35° C., and, in an embodiment, at 20° C. to 30° C., for 30 seconds to 50 seconds.

In an embodiment, the polarizer may have a polarization degree of 95% or more, and, in an embodiment, 95% to 100%, and, in an embodiment, 98% to 100%. Within this range, the polarizing plate can easily realize the effects of the present invention.

The polarizing plate may further include at least one second protective film stacked on the other surface (light incident surface) of the polarizer.

The second protective film is disposed on the light incident surface of the polarizer, through which internal light enters the polarizer, to further improve image quality or protect the polarizer by affecting light emitted from the polarizer.

The second protective film may include a protective film or a protective coating layer.

The protective film is an optically transparent film and may be formed of at least one resin selected from among, for example, cellulose based resins including triacetylcellulose (TAC) and the like, polyester based resins including polyethylene terephthalate, polybutylene terephthalate, polyethylene naphthalate (PET), polybutylene naphthalate, and the like, cyclic olefin polymer based resins, polycarbonate based resins, polyether sulfone based resins, polysulfone based resins, polyamide based resins, polyimide based resins, polyolefin based resins, polyarylate based resins, polyvinyl alcohol based resins, polyvinyl chloride based resins, and polyvinylidene chloride based resins. In an embodiment, the protective film may be a TAC film or a PET film. The protective coating layer may be formed of a composition for a heat curable coating layer and/or a composition for a photocurable coating layer.

In an embodiment, the second protective film may be a retardation film.

In an embodiment, the second protective film may have an in-plane retardation (Re) of 100 nm or less, for example, −50 nm to 80 nm, at a wavelength of 550 nm.

In an embodiment, the second protective film may have a thickness of 100 μm or less, and, in an embodiment, greater than 0 μm to 100 μm, and, in an embodiment, 10 μm to 90 μm. Within this thickness range, the second protective film can be used in the polarizing plate.

In an embodiment, the polarizing plate may have a Tc-to-total haze ratio of 0.35 or less, for example, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, or 0.35, and, in an embodiment, 0.1 to 0.35, and, in an embodiment, 0.11 to 0.35, and, in an embodiment, 0.11 to 0.25, as calculated according to the following Equation 2. Within this range, the effects of the present invention can be further improved.

$$Tc - to - total haze ratio = Tc ( 780 nm ) / total haze , \qquad Equation 2$$

where the total haze is a total haze of the first protective film (unit: %), and Tc (780 nm) denotes a crossed transmittance of the polarizing plate at a wavelength of 780 nm (unit: %).

In an embodiment, the polarizing plate may have a Tc-to-internal haze ratio of 5.0 or less, for example, 1, 1.5, 2, 2.5, 3, 3.5, 4, 4.5, or 5, and, in an embodiment, 1.0 to 4.0, and, in an embodiment, 1.5 to 3.0, as calculated according to the following Equation 3. Within this range, the effects of the present invention can be further improved.

$$Tc - to - in ternal haze ratio = Tc ( 780 nm ) / internal haze , \qquad Equation 3$$

where the internal haze is an internal haze of first protective film (unit: %), and Tc (780 nm) denotes a crossed transmittance of the polarizing plate at a wavelength of 780 nm (unit: %).

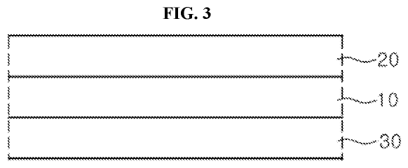

FIG. 3 is a cross-sectional view of a polarizing plate according to an embodiment of the present invention.

Referring to FIG. 3, the polarizing plate according to an embodiment may include a polarizer 10, a first protective film 20 stacked on an upper surface of the polarizer 10, and a second protective film 30 stacked on a lower surface of the polarizer 10. Although not shown in FIG. 3, an adhesive layer may be stacked on the lower surface of the second protective film 30 to adhere the polarizing plate to a panel therethrough.

An optical display apparatus according to the present invention includes the polarizing plate according to an embodiment of the present invention. In an embodiment, the optical display apparatus may include a liquid crystal display.

The liquid crystal display includes a liquid crystal panel, the polarizing plate according to an embodiment of the present invention on a light exit surface of the liquid crystal panel, and a polarizing plate (light source-side polarizing plate) on a light incident surface of the liquid crystal panel.

The polarizing plate disposed on the light incident surface of the liquid crystal panel may include a typical polarizing plate known to those skilled in the art. The polarizing plate according to the present invention may be used as a viewer-side polarizing plate. However, it is to be understood that the present invention is not limited thereto, and the polarizing plate according to the present invention may be used as either a viewer-side polarizing plate or a light source-side polarizing plate.

The liquid crystal panel may include liquid crystals oriented in response to application and non-application of voltage and may allow light emitted from a light source to be emitted therethrough in response to application of voltage. The liquid crystal panel may include a pair of substrates and a liquid crystal layer as a display medium interposed between the substrates. The substrate at a first side (color filter substrate) may be provided with a color filter and a black matrix, and the substrate at a second side (active matrix substrate) may be provided with a switching element (e.g., TFT) that controls electric and optical properties of the liquid crystals, and with signal lines and pixel lines that provide gate signals to the switching element, without being limited thereto.

The liquid crystal display includes a light source on a lower surface of the light source-side polarizing plate. The light source may include a light source providing a continuous light emission spectrum. For example, the light source may include a white LED light source, a quantum dot (QD) light source, a metal fluoride red phosphor light source, and, in an embodiment, a light source containing KSF (K₂SiF₆:Mn⁴⁺) phosphors or KTF (K₂TiF₆:Mn⁴⁺) phosphors, and the like.

Next, the present invention will be described in further detail with reference to some examples. However, it is to be understood that these examples are provided for illustration and are not to be construed in any way as limiting the present invention.

### Example 1

### (1) Manufacture of Polarizer

A polyvinyl alcohol based film (VF-TS #4500, thickness: 45 μm, Kuraray) washed with water at 25° C. was subjected to swelling treatment with water at 30° C. in a swelling bath.

After swelling treatment, the polyvinyl alcohol based film was dipped in a dyeing bath, which contains an aqueous solution containing 1 mol/ml of potassium iodide and 1 wt % of boric acid and has a temperature of 30° C., for 65 seconds. After dyeing treatment, the film was uniaxially stretched to 5.7 times in the MD of the film in a wet stretching bath containing an aqueous solution of 3 wt % of boric acid and having a temperature of 60° C. The stretched film was treated in a crosslinking bath containing an aqueous solution of 3 wt % of boric acid and having a temperature of 25° C., for 65 seconds.

After crosslinking treatment, the film was dipped in a color correction bath containing an aqueous solution of 4.5 wt % of potassium iodide and having a temperature of 30° C., for 10 seconds. After color correction, the film was washed with water and dried by hot air at 80° C. for 1 minute, thereby preparing a polarizer (thickness: 17 μm).

### (2) Manufacture of Polarizing Plate

A photocurable bonding agent (epoxy-based bonding agent) was applied to both surfaces of the prepared polarizer. A polarizing plate was manufactured by bonding a first protective film and a second protective film (cyclic olefin polymer film, COP, Zeon Co., Ltd.) to an upper surface (light exit surface) and a lower surface (light incident surface) of the polarizer, respectively. The first protective film is described in Table 1.

### Example 2

A polarizing plate was manufactured in the same manner as in Example 1 except that a protective film having total haze and internal haze as listed in Table 1 was used as the first protective film.

### Example 3

A polarizing plate was manufactured in the same manner as in Example 1 except that a protective film having total haze and internal haze as listed in Table 1 was used as the first protective film.

### Comparative Example 1

A polarizing plate was manufactured in the same manner as in Example 1 except that a polarizer was manufactured by treatment in a color correction bath containing an aqueous solution of 4.5 wt % of potassium iodide and having a temperature of 30° C., for 10 seconds, followed by washing with water and drying with hot air at 85° C. for 1 minute.

### Comparative Example 2

A polarizing plate was manufactured in the same manner as in Example 2 except that a polarizer was manufactured by treatment in a color correction bath containing an aqueous solution of 5.0 wt % of potassium iodide and having a temperature of 30° C. for 10 seconds, followed by washing with water and drying with hot air at 85° C. for 1 minute.

### Comparative Example 3

A polarizing plate was manufactured in the same manner as in Example 3 except that a polarizer was manufactured by treatment in a color correction bath containing an aqueous solution of 5.0 wt % of potassium iodide and having a temperature of 30° C. for 10 seconds, followed by washing with water and drying with hot air at 95° C. for 1 minute.

### Manufacture of Light Source-Side Polarizing Plate

A polarizer was manufactured in the same manner as above. A light source-side polarizing plate was manufactured by bonding a triacetylcellulose (TAC) film (KC4CT1SW, thickness: 40 μm, Konica Minolta Opto, Inc.) and a polyethylene terephthalate (PET) film (thickness: 80 μm, Re @550 nm: 8,400 nm, Rth@550 nm: 9,800 nm, Toyobo Co., Ltd.) to upper and lower surfaces of the polarizer, respectively.

### Manufacture of Liquid Crystal Module

An optical laminate manufactured in each of the Examples and Comparative Examples was adhered to a light exit surface of an IPS liquid crystal-containing liquid crystal panel via an adhesive layer. Here, a positive C layer of the optical laminate was adhered to the liquid crystal panel. A liquid crystal module was manufactured by bonding the manufactured light source-side polarizing plate to a light incident surface of the IPS liquid crystal-containing liquid crystal panel via an adhesive layer. Here, the TAC film of the light source-side polarizing plate was adhered to the liquid crystal panel.

The polarizing plates of the Examples and Comparative Examples were evaluated as to the following properties listed in Table 1.

(1) Crossed transmittance of polarizing plate (Tc, unit: %): With the polarizing plate of each of the Examples and Comparative Examples placed in a transmittance meter V-7100, crossed transmittance at a wavelength of 380 nm to 420 nm and at 780 nm were obtained by transmitting light from the first protective film side to the polarizer in the normal direction to the in-plane direction of the polarizing plate. A light transmittance ratio of Equation 1 was calculated based on the measured crossed light transmittance values.

(2) Single transmittance of polarizing plate (Ts, unit: %): With the polarizing plate of each of the Examples and Comparative Examples placed in a transmittance meter V-7100, single transmittance (average value) at a wavelength of 380 nm to 780 nm was obtained by transmitting light from the first protective film to the polarizer in the normal direction to the in-plane direction of the polarizing plate.

(3) Contrast ratio (no unit): A liquid crystal display (having a same configuration as Samsung TV (55″, Model: UN55KS8000F) except for a configuration of models for the liquid crystal displays of the Examples and Comparative Examples) including a single edge-type LED light source was manufactured by assembling an LED light source, a light guide plate and the model for measuring viewing angle. The contrast ratio was measured from a front side (0°, 0°) in a spherical coordinate system using an EZCONTRAST X88RC (EZXL-176R-F422A4, ELDIM). The contrast ratio was calculated as a luminance ratio of luminance in a white mode to luminance in a black mode. The present invention aims at achieving a contrast ratio of 6,000 or more according to the above measurement method.

(4) Matte texture: The same model as in (3) was assembled. It was evaluated with the naked eye whether a picture or a photo was clearly visible and was reproduced to have original texture (matte texture) of the picture or the photo such that the picture or the photo appeared to stick to a screen instead of floating off the screen, upon operation of the model to display the picture or the photo. Reproduction of original texture of an oil painting or photo was rated as good and failure in reproduction of the original texture of the oil paint or photo by displaying an unclear oil paint or photo was rated as poor.

TABLE 1

| | | | | Polarizing plate | | | | | | |
|---|---|---|---|---|---|---|---|---|---|---|
| | First protective film | | | | | Ts | | | | |
| | Internal | External | Total | | Maximum Tc | (@380 to | Ratio | Ratio | Contrast | Matte |
| | haze | haze | haze | Tc | (@780 nm) | 420 nm) | of Eq. 1 | of Eq. 2 | ratio | texture |
| Example 1 | 3.5 | 41.5 | 45 | 6.3642 | 0.0390 | 44.3 | 0.0061 | 0.1414 | 6190 | Good |
| Example 2 | 4.6 | 39.4 | 44 | 8.5927 | 0.0531 | 44.3 | 0.0062 | 0.1953 | 6095 | Good |
| Example 3 | 5.1 | 40.9 | 46 | 9.2143 | 0.0588 | 44.3 | 0.0064 | 0.2003 | 6077 | Good |
| Comparative | 3.5 | 41.5 | 45 | 17.9611 | 0.1731 | 44.3 | 0.0096 | 0.3991 | 5983 | Good |
| Example 1 | | | | | | | | | | |
| Comparative | 4.6 | 39.4 | 44 | 17.7819 | 0.1748 | 44.3 | 0.0098 | 0.4041 | 5886 | Good |
| Example 2 | | | | | | | | | | |
| Comparative | 5.1 | 40.9 | 46 | 17.2452 | 0.1796 | 44.3 | 0.0104 | 0.3749 | 5757 | Good |
| Example 3 | | | | | | | | | | |

First protective film A: LRB2-PET-1, DNP, total haze: 45%, internal haze: 3.5%
First protective film B: LRB2-PET-2, DNP, total haze: 44%, internal haze: 4.6%
First protective film C: LRB2-PET-3, DNP, total haze: 46%, internal haze: 5.1%

As shown in Table 1, the polarizing plates according to the present invention secured matte texture of a picture or a photo and high contrast ratios on the screen of the optical display apparatus. By contrast, although the polarizing plates of the Comparative Examples could provide a matte texture, the polarizing plates of the Comparative Examples had lower contrast ratios than those of the Examples.

Although some example embodiments have been described herein, it is to be understood that various modifications, changes, alterations, and equivalent embodiments can be made by those skilled in the art without departing from the spirit and scope of the invention.

What is claimed is:

1. A polarizing plate comprising:
a polarizer; and
a first protective film stacked on a surface of the polarizer,
wherein the first protective film has a total haze of 40% to 60% and an internal haze of 3% to 7%, and the polarizing plate has a light transmittance ratio of 0.008 or less, as calculated according to the following Equation 1:
Light transmittance ratio=Tc(380 nm to 420 nm)/Tc(780 nm),
where Tc (780 nm) denotes a crossed transmittance of the polarizing plate at a wavelength of 780 nm (unit: %), and
Tc (380 nm to 420 nm) denotes a maximum value of a crossed transmittance of the polarizing plate at a wavelength of 380 nm to 420 nm (unit: %).

2. The polarizing plate as claimed in claim 1, wherein the first protective film has an external haze-to-internal haze ratio of 9 to 20.

3. The polarizing plate as claimed in claim 1, wherein the first protective film comprises a base layer and an antiglare layer stacked on a surface of the base layer.

4. The polarizing plate as claimed in claim 3, wherein the antiglare layer comprises at least one selected from among organic particles and inorganic particles.

5. The polarizing plate as claimed in claim 1, wherein the polarizing plate has a light transmittance ratio of 0.003 to 0.008, as calculated according to Equation 1.

6. The polarizing plate as claimed in claim 1, wherein the polarizing plate has a crossed transmittance of 0% to 20% at a wavelength of 780 nm.

7. The polarizing plate as claimed in claim 1, wherein the maximum value of the crossed transmittance of the polarizing plate at a wavelength of 380 nm to 420 nm is present at a wavelength of 395 nm to 410 nm.

8. The polarizing plate as claimed in claim 1, wherein the maximum value of the crossed transmittance of the polarizing plate at a wavelength of 380 nm to 420 nm is 0.001% to 0.1%.

9. The polarizing plate as claimed in claim 1, wherein the polarizing plate has a Tc-to-total haze ratio of 0.35 or less, as calculated according to the following Equation 2:
Tc-to-total haze ratio=Tc(780 nm)/total haze,
where the total haze is a total haze of the first protective film (unit: %), and
Tc (780 nm) denotes a crossed transmittance of the polarizing plate at a wavelength of 780 nm (unit: %).

10. The polarizing plate as claimed in claim 1, wherein the polarizing plate has a Tc-to-internal haze ratio of 5.0 or less, as calculated according to the following Equation 3:
Tc-to-internal haze ratio=Tc(780 nm)/internal haze,
where the internal haze is an internal haze of the first protective film (unit: %), and
Tc (780 nm) denotes a crossed transmittance of the polarizing plate at a wavelength of 780 nm (unit: %).

11. The polarizing plate as claimed in claim 1, wherein the polarizing plate has a crossed transmittance of 1.0% to 1.3% in a machine direction of the polarizer and a crossed transmittance of 0.05% or less in a transverse direction of the polarizer at a wavelength of 380 nm.

12. The polarizing plate as claimed in claim 1, wherein the first protective film further comprises an antireflection layer stacked on a surface of the antiglare layer.

13. The polarizing plate as claimed in claim 1, wherein the first protective film is stacked alone on the surface of the polarizer.

14. The polarizing plate as claimed in claim 1, further comprising a second protective film stacked on another surface of the polarizer.

15. An optical display apparatus comprising the polarizing plate as claimed in claim 1.
